(19) United States
(12) Patent Application Publication
(10) Pub. No.: US 2025/0174214 A1
(43) Pub. Date: May 29, 2025

(54) MEDIA DATA GENERATION

(71) Applicants: Lemon Inc., Grand Cayman (KY); Beijing Zitiao Network Technology Co., Ltd., Beijing (CN)

(72) Inventors: Yilin ZHANG, Los Angeles, CA (US); Lingxuan SHEN, Beijing (CN)

(21) Appl. No.: 18/927,733

(22) Filed: Oct. 25, 2024

(30) Foreign Application Priority Data
Nov. 29, 2023 (CN) 202311618525.7

(51) Int. Cl. G10H 1/00; G10H 1/36

(52) U.S. Cl. CPC G10H 1/0025; G10H 1/36; G10H 2210/005; G10H 2210/066; G10H 2210/111; G10H 2210/125; G10H 2210/151; G10H 2210/325

(57) ABSTRACT

A method, an apparatus, a device, and a medium for generating media data are provided. In the method, the first media data is obtained in response to receiving a creation request for creating music. A music template is obtained, and the music template includes melody data for specifying a music melody. A second media data including a music melody is generated based on the first media data. According to the exemplary implementation of the present disclosure, a music creation tool may be provided for an ordinary user that does not have professional music knowledge, thereby meeting a simple music creation requirement of the ordinary user.

### CROSS-REFERENCE

This application claims the benefit of Chinese Patent Application No. 202311618525.7, filed on Nov. 29, 2023, and entitled “METHOD, APPARATUS, DEVICE AND MEDIUM FOR GENERATING MEDIA DATA”, which is hereby incorporated by reference in its entirety.

### FIELD

Example implementations of the present disclosure generally relate to data processing, and more particularly to generation of media data including music.

### BACKGROUND

In the field of music production, the use of digital synthesis techniques has been proposed to create musical works. For example, a musician may collect sounds using a tool, such as a sampler, and add these sounds into a musical work through a digital synthesis technique, so that the musical work has a richer hearing effect. However, the operation of existing music producing tools is complex and requires the user to have rich professional music knowledge, which is not friendly to ordinary users.

### SUMMARY

In a first aspect of the present disclosure, a method for generating media data is provided. In the method, the first media data is obtained in response to receiving a creation request for creating music. A music template is obtained, and the music template includes melody data for specifying a music melody. A second media data including a music melody is generated based on the first media data.

In a second aspect of the present disclosure, an apparatus for generating media data is provided. The apparatus includes a data obtaining module, a template obtaining module and a generating module, where the data obtaining module is configured to obtain first media data in response to receiving a creation request for creating music; the template obtaining module is configured to obtain a music template, the music template comprising melody data for specifying a music melody; and the generating module is configured to generate second media data including the music melody based on the first media data.

In a third aspect of the present disclosure, an electronic device is provided. The electronic device comprises at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The computer-readable storage medium has a computer program stored thereon, and the computer program, when executed by a processor, causes the processor to implement the method of the first aspect.

It should be understood that the content described in this section is not intended to limit the key features or important features of the implementations of the present disclosure, nor is it intended to limit the scope of the present disclosure. Other features of the present disclosure will become apparent from the following description.

### BRIEF DESCRIPTION OF THE DRAWINGS

The above and other features, advantages, and aspects of various implementations of the present disclosure will become more apparent from the following detailed description in conjunction with the accompanying drawings. In the drawings, the same or similar reference signs refer to the same or similar elements, in which:

FIG. 1 illustrates a block diagram of an application environment according to an exemplary implementation of the present disclosure;

FIG. 2 illustrates a block diagram for generating media data according to some implementations of the present disclosure;

FIG. 3 illustrates a block diagram of melody data according to some implementations of the present disclosure;

FIG. 4 illustrates a block diagram of a process for dividing a first media data into a plurality of audio segments according to some implementations of the present disclosure;

FIG. 5 illustrates a block diagram for establishing a mapping relationship between notes and audio segments according to some implementations of the present disclosure;

FIG. 6 illustrates a block diagram of a process for processing a plurality of audio segments according to some implementations of the present disclosure;

FIG. 7 illustrates a block diagram of a process for synthesizing melody audio and accompaniment audio according to some implementations of the present disclosure;

FIG. 8 illustrates a block diagram of a process for generating video data according to some implementations of the present disclosure;

FIGS. 9A and 9B respectively illustrate a block diagram of a page for generating media data according to some implementations of the present disclosure;

FIG. 10 illustrates a flowchart of a method for generating media data according to some implementations of the present disclosure;

FIG. 11 illustrates a block diagram of an apparatus for generating media data according to some implementations of the present disclosure; and

FIG. 12 illustrates a block diagram of a device capable of implementing various implementations of the present disclosure.

### DETAILED DESCRIPTION

The embodiments of the present disclosure will be described in more detail below with reference to the accompanying drawings. Although some embodiments of the present disclosure are illustrated in the drawings, it should be understood that the present disclosure can be implemented in various forms and should not be construed as being limited to the embodiments set forth herein. Rather, these embodiments are provided for a more thorough and complete understanding of the present disclosure. It should be understood that the drawings and the embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “an embodiment” or “the embodiment” should be understood as “at least one embodiment”. The term “some embodiments” should be understood as “at least some of the embodiments”. Other explicit and implicit definitions may also be included below. As used herein, the term “model” may represent an association relationship between various data. For example, the association relationship may be obtained based on various technical solutions currently known and/or to be developed in the future.

It is to be understood that the data involved in the technical solution, including but not limited to the data itself, the obtaining or use of the data, should comply with the requirements of corresponding laws and regulations and relevant provisions.

It is to be understood that, before using the technical solutions disclosed in the various embodiments of the present disclosure, the user shall be informed of the type, the scope of use, and use scenarios and so on of personal information involved in the present disclosure in an appropriate manner in accordance with relevant laws and regulations, and the user's authorization shall be obtained.

For example, in response to receiving an active request from a user, prompt information is sent to the user to explicitly prompt the user that an operation requested by the user will require to obtain and use personal information of the user, so that the user can autonomously select, according to the prompt information, whether to provide the personal information to software or hardware, such as an electronic device, an application program, a server, or a storage medium that performs the operations of the technical solutions of the present disclosure.

As an optional but non-limiting implementation, in response to receiving an active request of the user, the prompt information is sent to the user, for example, in the form of a pop-up window, in which the prompt information may be presented in the form of text. In addition, the pop-up window may further carry a selection control for the user to select “agree” or “not agree” to provide the personal information to the electronic device.

It should be understood that the above process for notifying and obtaining the user's authorization is merely illustrative, and do not limit the implementations of the present disclosure, and other approaches that meet the relevant laws and regulations may also be applied to the implementations of the present disclosure.

### Example Environment

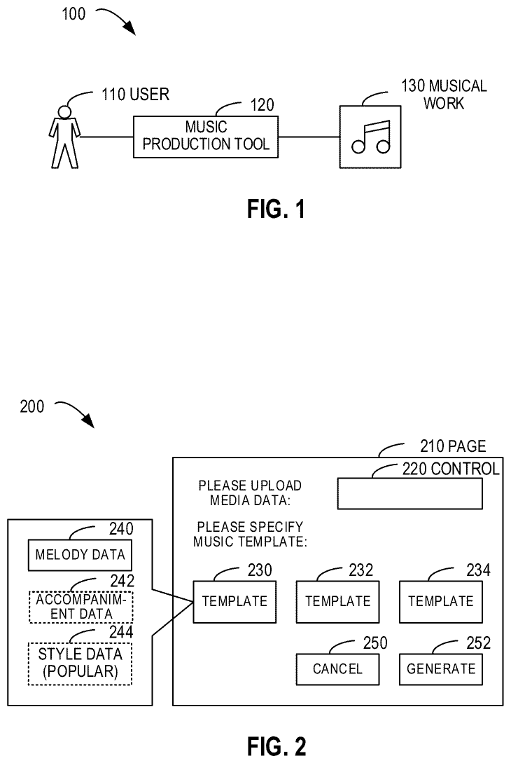

In the field of music production, use of digital synthesis technique has been proposed to create musical works. For example, a musician may collect sounds and utilize a professional music production tool to create musical works. FIG. 1 is a block diagram 100 of an application environment according to an example implementation of the present disclosure. As shown in FIG. 1, a user 110 (e.g., a professional musician) may create a musical work 130 with assistance of a music production tool 120.

It should be understood that the music production tool 120 herein may be a professional tool, the operations of these tools are complex, and the user 110 is required to have sophisticated professional musical knowledge and rich software use skills. For example, the user 110 may collect sound, use the music production tool 120 to process the sound, and then add a corresponding sound effect to the music work 130, etc.

However, existing music production tools 120 are not friendly to ordinary users (e.g., ordinary users who do not have professional music knowledge and software use skills). For example, a user may wish to utilize sound of his own pet to generate a piece of music, or utilize his own voice to sing a hot song, and so on. The existing music production tools cannot meet simple music creation requirements of ordinary users. At this point, it is desirable to provide auxiliary tools to ordinary users and/or professional users in a simpler and efficient manner in order to generate a desired musical work.

### Generation of a Summary of Media Data

In order to at least partially solve the deficiencies in the prior art, according to an exemplary implementation of the present disclosure, a method for generating media data is provided. Referring to FIG. 2, a summary is described according to an exemplary implementation of the present disclosure, and FIG. 2 illustrates a block diagram 200 for generating media data according to some implementations of the present disclosure. As shown in FIG. 2, a music production tool may be provided, and in a case where a creation request for creating music is received, the music production tool may present a page 210. The page 210 may include a control 220 for uploading media data (e.g., it may be referred to as first media data), and one or more controls 230, 232, 234, etc. for specifying a music template.

Specifically, the user may upload the first media data via the control 220, and the first media data may include timbre that the user desires to specify. It should be understood that the timbre refers to an essential feature of sound, and it is the most fundamental feature for distinguishing a sound from other sounds. The timbre depends on a waveform of the sound, and different waveforms correspond to different timbres. For example, voices of different people have different timbres, voices of people and sounds of animals have different timbres, and so on. If the musical work desired to be generated by the user includes the timbre of a pet, a piece of audio (and/or video) including sound of the pet may be uploaded. For another example, if the musical work desired to be generated by the user includes his or her own timbre, a piece of audio (and/or video) including his or her own speaking or singing may be uploaded.

Further, the user may specify a melody of the musical work desired to be generated via a music template. For example, a music template may be obtained via a control 230 or the like, and the music template includes melody data 240 for specifying a music melody. It should be understood that, in the context of the present disclosure, the melody data 240 may include a main melody of a song, a segment of a main melody, or any melody that a user desires to specify, and the like. The user may interact with various controls in the page 210 to specify desired media data and music templates. In this case, the music production tool may receive the media data and the music template specified by the user, and then generate the new media data (for example, it may be referred to as second media data). At this time, the new media data may have a timbre specified in the media data and have a melody specified by the music template.

According to one example implementation of the present disclosure, the second media data and the first media data may have the same timbre, and the timbre is specified by the first media data. In this way, the user may be facilitated to generate musical works with desired timbre and desired melody in a simpler and more efficient manner. Specifically, assuming that the user uploads media data of the pet's barking and the selected template includes melody data of the song A, the generated media data may include a melody of the song A sung using the pet's sound. For another example, assuming that the user uploads media data including his or her own speaking sound, and the selected template includes melody data of the song B, the media data generated at this time may include a melody of the song B sung by the user himself. According to example implementations of the present disclosure, a music creation tool may be provided to an ordinary user that does not have professional music knowledge, thereby meeting a simple music creation requirement of the ordinary user.

### Detailed Procedure for Generating Media Data

A summary in accordance with one example implementation of the present disclosure has been described with reference to FIG. 2, and more details regarding generation of media data will be provided in the following. It should be understood that an example of a music template specifying media data to be generated is shown above by way of example only. Alternatively, and/or additionally, the music template may be utilized to specify other aspects of media data to be generated. For example, the music template may further include accompaniment data 242, and the generated second media data at this time may further include accompaniment data. For example, different data may be processed in an audio mixing manner, so that the music work has a richer effect.

According to an example implementation of the present disclosure, the music template further includes style data 244 for specifying a music style, and the second media data generated at this time will further have the music style. For example, a popular style, a rock style, a classical style, etc. may be specified. In this way, a musical work with richer effect can be generated.

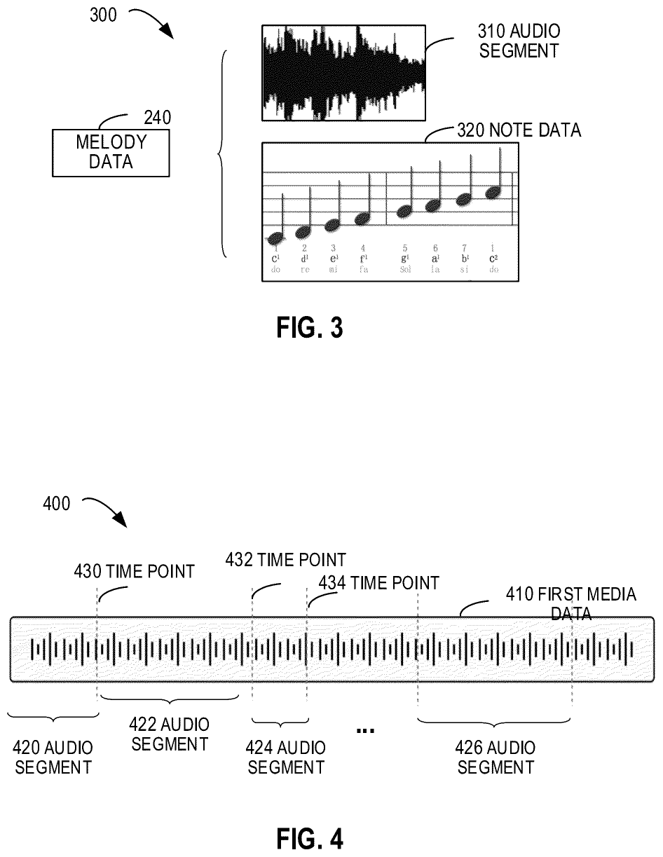

According to one example implementation of the present disclosure, the melody data 240 may include a set of notes, each of which corresponds to a respective time length. At this time, the melody data 240 may specify a main melody to be used, each melody may include a plurality of notes arranged in chronological order, and only a single note is present at one time point. Referring to FIG. 3, more details regarding melody data 240 are described. FIG. 3 illustrates a block diagram 300 of melody data in accordance with some implementations of the present disclosure. As shown in FIG. 3, the melody data 240 may be represented in a variety of ways, for example, the audio data 310 may be used to represent the melody data 240. In this case, the audio data 310 may include, for example, data in MIDI format with speed information (e.g., Beat Per Minute, abbreviated as BPM), or data in a MusicXML format, and so on.

Alternatively, and/or additionally, the melody data 240 may be represented using note data 320 with speed information. For example, the note data 320 may be represented using a stave, Numbered Musical Notation, or any other means that may be identified. According to one example implementation of the present disclosure, a page specifying melody data 240 may be provided to a user. For example, audio data and/or note data imported by a user may be received to determine a main melody of the media data to be generated.

According to an example implementation of the present disclosure, when the melody data 240 has been determined, a corresponding audio segment may be searched for each note in the melody data 240 from the first media data, and then the second media data is generated. Specifically, the second media data may be generated by: dividing the first media data into a plurality of audio segments based on pitch information in the first media data; and generating the second media data using the plurality of audio segments. It should be understood that each audio segment has a specified timbre, so that the second media data generated by using respective audio segments will have the specified timbre.

Hereinafter, referring to FIG. 4, more details about dividing the audio segments are described, and FIG. 4 illustrates a block diagram 400 of a process for dividing the first media data into a plurality of audio segments according to some implementations of the present disclosure. According to an example implementation of the present disclosure, pitches at different time points in the first media data 410 may be detected to divide the first media data into a plurality of audio segments. It should be understood that the pitch refers to the high or low quality of sound, which depends on the vibration frequency of the speaker. The faster the vibration frequency, the higher the pitch, whereas the slower the vibration frequency, the lower the pitch.

According to an example implementation of the present disclosure, before the dividing operation, preprocessing may also be performed on the received first media data, for example, noise reduction processing may be performed to eliminate ambient noise, audio track separation may be performed to extract melody data, reverberation cancellation may be performed to obtain clean melody data, and so on. According to an example implementation of the present disclosure, the pitch at each time point may be detected based on a digital signal processing algorithm, and then the division process is performed. A portion between the initial time point and the time point 430 may be used as the audio segment 420, a portion between the time points 430 and 432 may be used as the audio segment 422, and a portion between the time points 432 and 434 may be used as the audio segment 424, and so on. In this way, a plurality of audio segments 420, 422, 424, . . . , and 426 may be obtained in a simple and efficient manner.

According to an example implementation of the present disclosure, a large number of audio segments may be obtained based on pitch detection, and some of high-quality audio segments may be selected from a large number of audio segments. For example, the audio segment may be selected based on a condition that a time length of the target audio segment satisfying a predetermined length condition; energy of the target audio segment satisfying a predetermined energy condition; and a pitch difference of the target audio segment satisfying a predetermined pitch condition, and so on.

In particular, audio segments that are too short in time length may be discarded, and only audio segments with time length meeting a predetermined length condition (e.g., not below 0.3 seconds or other numerical value) are retained. Audio segments with too little energy (e.g., volume) may be discarded, and only audio segments with energy satisfying a predetermined energy condition (e.g., the root mean square of the audio segment exceeds a predetermined threshold) may be retained. The audio segment with large pitch difference (i.e., the pitch range spanned by the audio segment) may be discarded, and only the audio segments satisfying the predetermined pitch condition are retained. According to an example implementation of the present disclosure, the plurality of audio segments may be sorted in ascending order based on pitch differences of the plurality of audio segments, and then the first K (e.g., 10 or other values) audio segments are selected. At this time, the pitch differences of the selected audio segments are small, and thus the selected audio segments can be mapped to the notes in the melody data 240 in a more accurate manner.

According to one example implementation of the present disclosure, the second media data may be generated by selecting, from the plurality of audio segments, a set of audio segments respectively corresponding to the set of notes, the target note in the set of notes corresponding to a target audio segment in the set of audio segments; and creating the second media data using the set of audio segments. In this way, a set of notes may be respectively mapped to a set of audio segments in the plurality of audio segments, so that each note in the melody data may be converted into an audio segment having the specified timbre in a simple and effective manner.

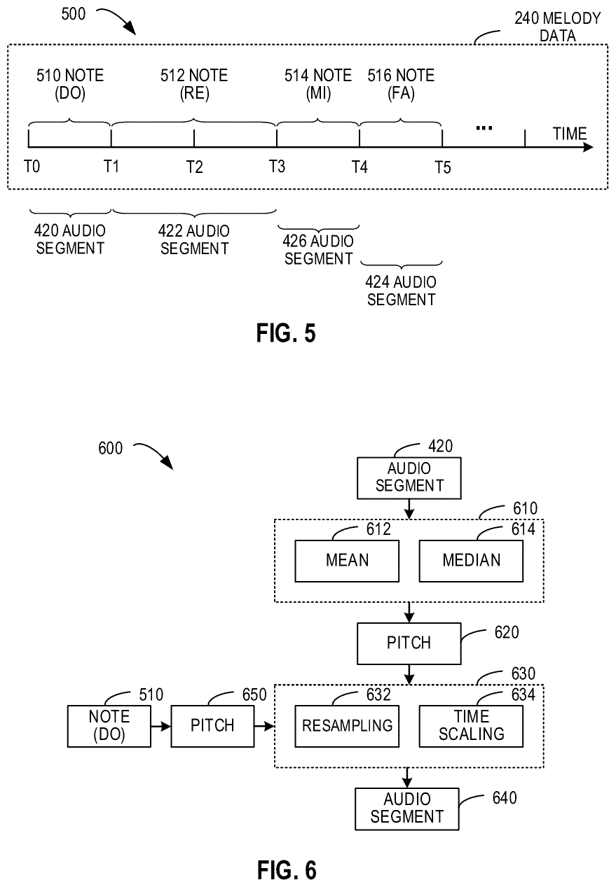

More details are described with reference to FIG. 5. FIG. 5 illustrates a block diagram 500 for establishing a mapping relationship between notes and audio segments in accordance with some implementations of the present disclosure. As shown in FIG. 5, it is assumed that melody data 240 includes a plurality of notes, each of which may correspond to a respective time length. For example, a note 510 (do) may correspond to a time period t0-t1, a note 512 (re) may correspond to a time period t1-t3, a note 514 (mi) may correspond to a time period t3-t4, a note 516 (fa) may correspond to a time period t4-t5, and so on.

At this time, for the target note in the plurality of notes, the target note may be mapped to a certain audio segment in the plurality of audio segments. For example, the note 510 may be mapped to the audio segment 420, the note 512 may be mapped to the audio segment 422, the note 514 may be mapped to the audio segment 426, the note 516 may be mapped to the audio segment 420, and so forth.

According to an example implementation of the present disclosure, the mapping relationship may be established in a plurality of manners. For example, a corresponding target audio segment may be selected for the target note based on a random selection mode, in this case, the audio segments corresponding to the individual notes 510 are randomly selected. For another example, a corresponding target audio segment may be selected for the target note based on a poll selection mode. Assuming that 10 audio segments are generated by the dividing operation, the first audio segment can be selected for the first note in the melody data, the second audio segment can be selected for the second note, . . . , the eleventh audio segment is selected for the first note, and so on.

Alternatively, and/or additionally, the time length corresponding to the target note may be compared with the time length of the target audio segment, and an audio segment with the closest time length may be selected for the target note. According to example implementations of the present disclosure, the audio segment with a matched length is selected for each note, thereby reducing the amplitude of the time scaling operation performed on the audio segments in subsequent operations. Alternatively, and/or additionally, a pitch corresponding to the target note may be compared with the pitch of the target audio segment, and the audio segment with the closest pitch may be selected for the target note. According to example implementations of the present disclosure, an audio segment with a matched pitch is selected for each note, thereby reducing the amplitude of time and pitch adjustment performed on the audio segment in subsequent operations.

With continued reference to FIG. 5, corresponding audio segments have been specified for respective notes, at which point the lengths of the audio segments can be adjusted in accordance with the time lengths of respective notes. For example, a length may be truncated to obtain a shorter audio segment, and a longer audio segment may be obtained, for example, by copying. Alternatively, and/or additionally, the pitch of an audio segment may be adjusted according to the pitch of a respective note. In this way, the pitches and time lengths of a set of audio segments may be adjusted to match a set of notes, respectively, and then the second media data may be generated by combining the adjusted set of audio segments. In this way, the pitch and the length of each audio segment can be matched with the pitch and the length of the corresponding note, thereby obtaining the music work with a specified timbre and a specified melody at the same time.

More details are described with reference to FIG. 6, which illustrates a block diagram 600 of a process for processing a plurality of audio segments in accordance with some implementations of the present disclosure. As shown in FIG. 6, the process of adjusting the pitch is described by taking only the audio segment 420 as an example of a plurality of audio segment. At block 610, the pitch 620 of the audio segment 420 may be determined, for example, the pitch 620 may be determined based on the mean 612 of pitches at various time points of the audio segment 420. Alternatively, and/or additionally, the pitch 620 may be determined based on a median 614 of the pitches at various time points of the audio segment 420.

It should be understood that the pitch 620 is determined by the frequency of the sound waves. Thus, at block 630, the frequency of sound may be adjusted by resampling 632 and/or time scaling 634. Specifically, the resampling 632 may include upsampling or downsampling, in this manner, the frequency of the sound may be adjusted. Further, stretching or compressing the time length of the audio segment may also change the frequency of the sound, thereby obtaining the sound with the desired pitch in an accurate manner. For example, the pitch 650 of the note 510 may be obtained, and then the same pitch 650 may be obtained by resampling 632 and/or time scaling 634, and in this case, the pitch of the obtained audio segment 640 is the same as the pitch of the note 510.

It should be understood that although FIG. 6 only describes the process of performing the pitch adjustment by adjusting the pitch of the audio segment 420 as an example, alternatively, and/or additionally, the pitch of other audio segments may be adjusted in a similar manner. Returning to FIG. 5, the pitch of the audio segment 422 may be adjusted to match the note 512, the pitch of the audio segment 426 may be adjusted to match the note 514, the pitch of the audio segment 424 may be adjusted to match the note 516, and so on. In this case, the adjusted audio segments may be connected to obtain the second media data.

Alternatively, and/or additionally, a smoothing process may be performed between various audio segments to obtain a smoother musical work. With example implementations of the present disclosure, a musical work having a specified timbre and melody may be generated in an accurate manner by replacing each note in melody data with an audio segment having a specified timbre and a corresponding pitch.

According to an example implementation of the present disclosure, a plurality of sound effect processing may be performed on the generated second media data, thereby improving the auditory experience of the music work. For example, special effect processing may be performed to add a special sound effect to the second media data; for another example, gain processing may be performed to adjust the volume, and so on. In particular, a variety of audio processing techniques currently known and/or that will be developed in the future may be utilized such that the musical work exhibits a better auditory effect. According to an example implementation of the present disclosure, the music template may further include accompaniment data. At this time, the accompaniment data may be added to the musical work.

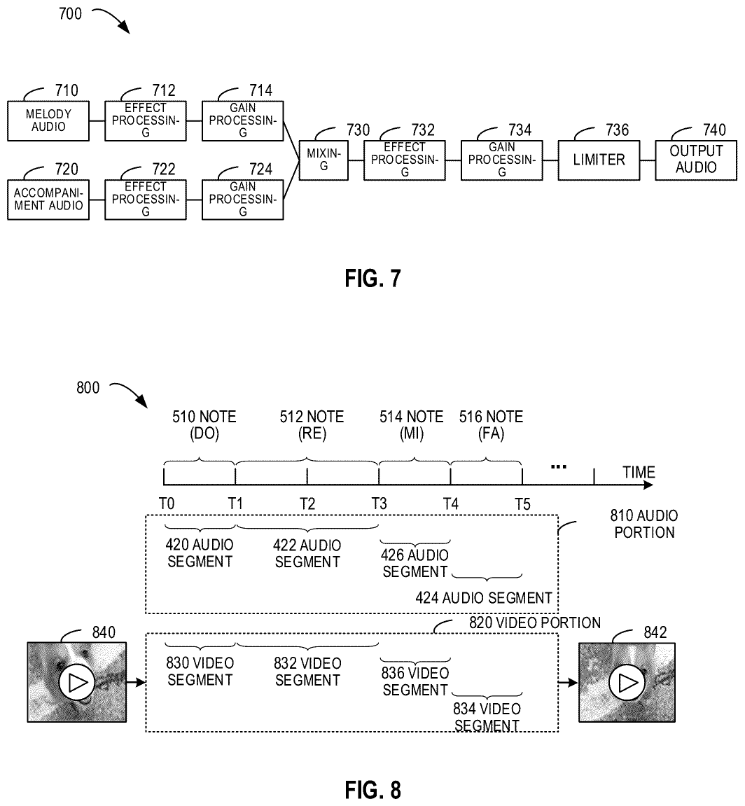

Referring to FIG. 7, more details are described according to an example implementation of the present disclosure, and FIG. 7 illustrates a block diagram 700 of a process for synthesizing melody audio and accompaniment audio according to some implementations of the present disclosure. As shown in FIG. 7, melody audio 710 may be generated in the manner described above, and in this case, the melody audio 710 has a specified timbre and melody. Further, the accompaniment audio 720 specified in the music template may be obtained, and the final output audio 740 may be generated based on both the melody audio 710 and the accompaniment audio 720. It should be understood that the accompaniment audio 720 and melody data should have the same beat speed in order to generate more harmonious output audio.

As shown in FIG. 7, the special effect processing 712 and gain processing 714 may be performed on the melody audio 710, similarly, the special effect processing 722 and gain processing 724 may be performed on the accompaniment audio 720. Further, the audio mixing 730 may be performed, and then the melody audio and the accompaniment audio are combined together. In turn, the special effect processing 732, gain processing 734, limiter 736 processing, etc. may be performed in a number of manners currently known and/or that will be developed in the future to obtain the final output audio 740. In this case, the output audio 740 may have a specified timbre and melody, and have beautiful accompaniment data.

It should be understood that the process of generating a musical work is described above with audio data as a specific example of the first media data and the second media data. Alternatively, and/or additionally, the first media data and the second media data may further include video data. At this point, the audio portion in the media data may be processed based on the manner described above. Further, the video portion in the media data may be processed in a similar manner.

More details are described with reference to FIG. 8, which illustrates a block diagram 800 of a process for generating video data in accordance with some implementations of the present disclosure. As shown in FIG. 8, video data 840 may be received and video data 842 may be generated. The audio portion 810 in the video data 840 may be processed in the manner described above. Specifically, a set of audio segments, such as audio segments 420, 422, 426, and 424, may be obtained. Further, the timestamps of the audio portion 810 and the video portion 820 may be aligned to obtain a set of video segments (e.g., video segments 830, 832, 836, 834, etc.,) corresponding to a set of audio segments, respectively. Further, the set of video segments may be utilized to generate the video portion 820 in the second media data. At this time, the media data 842 including richer information can be generated by combining both the audio portion 810 and the video portion 820.

With example implementations of the present disclosure, it is assumed that the media data 840 is a video including dog barking, and the melody data specified by the user is Song A. The media data 842 generated at this time includes the song A sung in a dog sound, and the mouth shape of the dog in the video screen will match the mouth shape when singing. In this way, a personalized music creation may be implemented in a simpler and efficient manner to provide more creating tools for ordinary users who do not have professional musical knowledge.

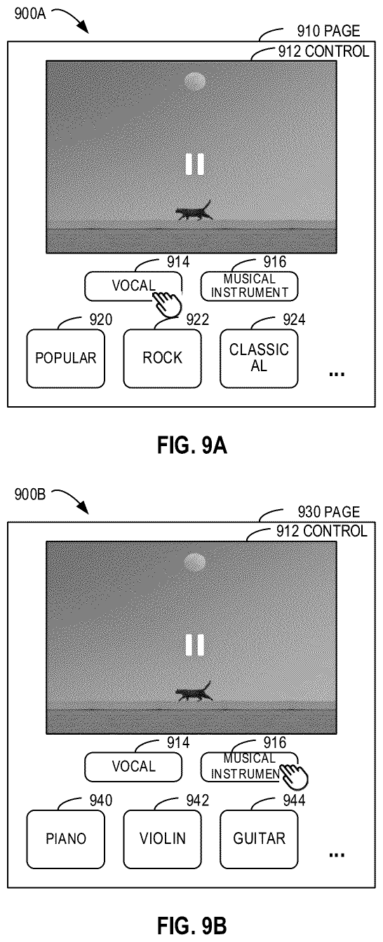

Referring to FIG. 9A and FIG. 9B, more details on generating a page are described, and FIG. 9A illustrates a block diagram 900A of a page for generating media data according to some implementations of the present disclosure. As shown in FIG. 9A, a page 910 may be provided. The user may click on the control 912 to specify the desired melody data (e.g., specifying Song A). In turn, the user may select the desired timbre by the control 914 or 916. In a case of the user selecting a control 914, a plurality of music styles may be provided, such as a popular style 920, a rock style 922, a classical style 924, and so on.

At this time, the user may select the desired style, and at this time, the media data of the song A with the specified style and sung with vocals will be generated. Assuming that the user selects a Rock 922 style, the generated media data may have a Rock style, for example, the accompaniment music may have an explicit rhythm and may be accompanied by musical instruments such as guitars, basses, and drums. Assuming that the user selects a Rock 9924 style, the generated media data may have a classical style, for example, a piano accompaniment may be used.

FIG. 9B illustrates a block diagram 900B of a page for generating media data, respectively, according to some implementations of the present disclosure. As shown in FIG. 9B, assuming that the user selects a musical instrument 916, a control may be provided for selecting a variety of musical instruments. The user may, for example, select a piano 940, a violin 942, or others 944, etc. At this point, the timbre of the corresponding musical instrument will be automatically specified, and the media data having the specified melody is generated using an audio including the playing of the specified musical instrument. Assuming that the user specifies a song A and specifies the piano 940, audio played by the piano (e.g., first media data) may be automatically obtained. In turn, the audio (e.g., the second media data) of the song A including playing of the piano timbre may be generated in the manner described above. In this way, a plurality of selection manners may be provided to an ordinary user, thereby generating media data including richer and flexible content.

With example implementations of the present disclosure, a plurality of music creation scenarios may be supported. For example, a user may utilize a specified timbre to adapt existing songs, or a user may create a song from scratch. For example, a user may use sound of his own pet to adapt existing songs. For another example, a user may be supported to create a new song, and the user only needs to upload a piece of audio and/or video with voice. For example, the user may edit the note data in the melody data in order to generate a new melody. In turn, completely new songs can be created by selecting different styles and/or different musical instruments.

### Example Process

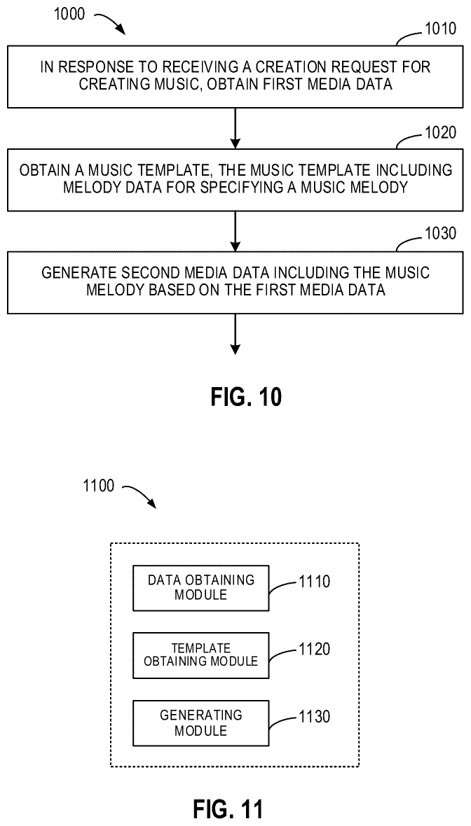

FIG. 10 illustrates a flowchart of a method 1000 for generating media data according to some implementations of the present disclosure. At block 1010, in response to receiving a create request to create music, first media data is obtained. At block 1020, a music template is obtained, the music template including melody data for specifying a music melody. At block 1030, second media data including a music melody is generated based on the first media data.

According to one example implementation of the present disclosure, the second media data and the first media data have a same timbre and the timbre is specified by the first media data.

According to one example implementation of the present disclosure, the music template further includes accompaniment data, and the second media data further includes the accompaniment data.

According to one example implementation of the present disclosure, the music template further includes style data for specifying a music style, and the second media data further has a music genre.

According to one example implementation of the present disclosure, the melody data includes a set of notes, each note in the set of notes corresponds to a respective time length, and the second media data is generated by dividing the first media data into a plurality of audio segments based on pitch information in the first media data; and generating the second media data using the plurality of audio segments.

According to an example implementation of the present disclosure, the target audio segment in the plurality of audio segments satisfies the following conditions: a time length of the target audio segment satisfying a predetermined length condition; energy of the target audio segment satisfying a predetermined energy condition; and a pitch difference of the target audio segment satisfying a predetermined pitch condition.

According to one example implementation of the present disclosure, the second media data is generated based on the following: selecting a set of audio segments respectively corresponding to the set of notes from the plurality of audio segments, a target note in the set of notes corresponding to a target audio segment in the set of audio segments; and creating the second media data using the set of audio segments.

According to an example implementation of the present disclosure, the target audio segment is selected based on at least one of the following: a random selection mode; a polling selection mode; comparison of a time length corresponding to the target note with a time length of the target audio segment; and comparison of a pitch corresponding to the target note with a pitch of the target audio segment.

According to one example implementation of the present disclosure, the second media data is created based on the following: adjusting pitches and time lengths of the set of audio segments respectively to match the set of notes; and combining the adjusted set of audio segments to generate the second media data.

According to one example implementation of the present disclosure, a pitch of the target audio segment in the set of audio segments is adjusted based on at least one of: performing resampling on the target audio segment, and scaling a time length of the target audio segment.

According to one example implementation of the present disclosure, the first media data and the second media data comprise video data, and a video portion in the second media data is generated based on the following: obtaining a set of video segments respectively corresponding to the set of audio segments; and generating the video portion in the second media data using the set of video segments.

According to an example implementation of the present disclosure, the melody data is represented by at least one of: audio data and note data.

According to one example implementation of the present disclosure, the creation request further specifies a musical instrument for creating the music, and the first media data and the second media data are played by using the musical instrument.

### Example Apparatus and Device

FIG. 11 illustrates a block diagram of an apparatus 1100 for generating media data according to some implementations of the present disclosure. The apparatus 1100 includes: a data obtaining module 1110 configured to obtain first media data in response to receiving a creation request for creating music; a template obtaining module 1120 configured to obtain a music template, the music template comprising melody data for specifying a music melody; and a generating module 1130 configured to generate second media data comprising the music melody based on the first media data.

According to one example implementation of the present disclosure, the second media data and the first media data have a same timbre and the timbre is specified by the first media data.

According to one example implementation of the present disclosure, the music template further includes accompaniment data, and the second media data further includes the accompaniment data.

According to one example implementation of the present disclosure, the music template further includes style data for specifying a music style, and the second media data further has a music genre.

According to one example implementation of the present disclosure, the melody data includes a set of notes, each note in the set of notes corresponds to a respective time length, and the generating module is further configured to divide the first media data into a plurality of audio segments based on pitch information in the first media data; and generate the second media data using the plurality of audio segments.

According to an example implementation of the present disclosure, the target audio segment in the plurality of audio segments satisfies the following conditions: a time length of the target audio segment satisfying a predetermined length condition; energy of the target audio segment satisfying a predetermined energy condition; and a pitch difference of the target audio segment satisfying a predetermined pitch condition.

According to one example implementation of the present disclosure, the generating module is further configured to: select a set of audio segments respectively corresponding to the set of notes from the plurality of audio segments, a target note in the set of notes corresponding to a target audio segment in the set of audio segments; and create the second media data using the set of audio segments.

According to an example implementation of the present disclosure, the target audio segment is selected based on at least one of the following: a random selection mode; a polling selection mode; comparison of a time length corresponding to the target note with a time length of the target audio segment; and comparison of a pitch corresponding to the target note with a pitch of the target audio segment.

According to an example implementation of the present disclosure, the generating module is further configured to: adjust pitches and time lengths of the set of audio segments respectively to match the set of notes; and combine the adjusted set of audio segments to generate the second media data.

According to one example implementation of the present disclosure, a pitch of the target audio segment in the set of audio segments is adjusted based on at least one of: performing resampling on the target audio segment, and scaling a time length of the target audio segment.

According to one example implementation of the present disclosure, the first media data and the second media data comprise video data, and the generating module is further configured to obtain a set of video segments respectively corresponding to the set of audio segments; and generate the video portion in the second media data using the set of video segments.

According to an example implementation of the present disclosure, the melody data is represented by at least one of: audio data and note data.

According to one example implementation of the present disclosure, the creation request further specifies a musical instrument for creating the music, and the first media data and the second media data are played by using the musical instrument.

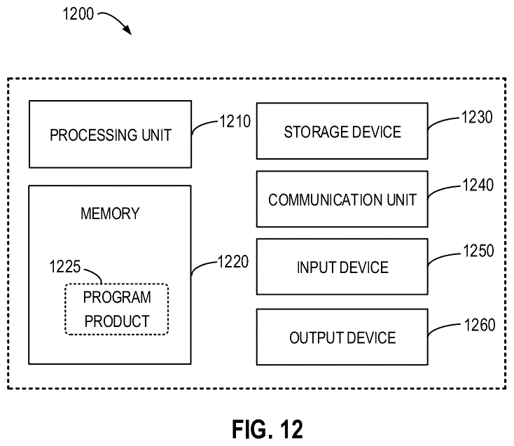

FIG. 12 illustrates a block diagram of a device 1200 in which embodiments of the present disclosure may be implemented. It should be understood that the computing device 1200 in FIG. 12 is shown for merely illustrative purpose, and should not limit the functionality and scope of the embodiments described herein. The computing device 1200 shown in FIG. 12 may be configured to implement the method described above.

As shown in FIG. 12, the computing device 1200 is in the form of a general-purpose computing device. Components of the computing device 1200 may include, but are not limited to, one or more processors or processing units 1210, a memory 1220, a storage device 1230, one or more communications units 1240, one or more input devices 1250, and one or more output devices 1260. The processing unit 1210 may be a physical or virtual processor and can perform various processing according to a program stored in the memory 1220. In a multiprocessor system, a plurality of processing units executes computer executable instructions in parallel, so as to improve the parallel processing capability of the computing device 1200.

The computing device 1200 typically includes a plurality of computer storage medium. Such media may be any available media that are accessible by the computing device 1200, including, but not limited to, volatile and non-volatile media, removable and non-removable media. The memory 1220 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 1230 may be a removable or non-removable medium and may include a machine-readable medium, such as a flash drive, a magnetic disk, or any other medium that can be used to store information and/or data (e. g., training data for training) and that can be accessed within the computing device 1200.

The computing device 1200 may further include additional detachable/undetachable, volatile/nonvolatile storage medium. Although not shown in FIG. 6, a magnetic disk drive for reading from or writing to a detachable, nonvolatile magnetic disk, such as a “floppy disk” and an optical disk drive for reading from or writing to a detachable, nonvolatile optical disk may be provided. In these cases, each drive may be connected to a bus (not shown) by one or more data media interfaces. The memory 1220 may include a computer program product 1225 having one or more program modules configured to perform various methods or actions of various embodiments of the present disclosure.

The communication unit 1240 implements communication with other computing devices through a communication medium. Additionally, functions of components of the computing device 1200 may be implemented by a single computing cluster or a plurality of computing machines, and these computing machines can communicate through a communication connection. Thus, the computing device 1200 may operate in a networked environment using logical connections to one or more other servers, network personal computers (PCs), or another network node.

The input device 1250 may be one or more input devices, such as a mouse, a keyboard, a trackball, etc. The output device 1260 may be one or more output devices, such as a display, a speaker, a printer, etc. The computing device 1200 may also communicate with one or more external devices (not shown), such as a storage device, a display device, or the like through the communication unit 1240 as desired, and communicate with one or more devices that enable a user to interact with the computing device 1200, or communicate with any device (e.g., a network card, a modem, or the like) that enables the computing device 1200 to communicate with one or more other computing devices. Such communication may be performed via an input/output (I/O) interface (not shown).

According to an example implementation of the present disclosure, a computer readable storage medium is provided, on which computer-executable instructions is stored, wherein the computer-executable instructions are executed by a processor to implement the method described above. According to an example implementation of the present disclosure, a computer program product is also provided, which is tangibly stored on a non-transitory computer readable medium and includes computer-executable instructions that are executed by a processor to implement the method described above. According to the example embodiments of the present disclosure, there is provided a computer program product having a computer program stored thereon, and the computer program, when executed by a processor, implements the method described above.

Aspects of the present disclosure are described herein with reference to flowcharts and/or block diagrams of methods, apparatus, devices and computer program products implemented in accordance with the present disclosure. It should be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, when executed via the processing unit of the computer or other programmable data processing apparatus, create means for implementing the functions/actions specified in one or more blocks of the flowcharts and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture that includes instructions which implement various aspects of the functions/actions specified in one or more blocks of the flowcharts and/or block diagrams.

The computer readable program instructions may be loaded onto a computer, other programmable data processing apparatus, or other devices, causing a series of operational steps to be performed on the computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is example, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for generating media data, comprising:
in response to receiving a creation request for creating music, obtaining first media data;
obtaining a music template, the music template comprising melody data for specifying a music melody; and
generating second media data comprising the music melody based on the first media data.

2. The method of claim 1, wherein the second media data and the first media data have a same timbre and the timbre is specified by the first media data.

3. The method of claim 1, wherein the music template further comprises accompaniment data and the second media data further comprises the accompaniment data.

4. The method of claim 1, wherein the music template further comprises style data for specifying a music style, and the second media data further has the music style.

5. The method of claim 1, wherein the melody data comprises a set of notes, each note in the set of notes corresponds to a respective time length, and the second media data is generated by the following:
dividing the first media data into a plurality of audio segments based on pitch information in the first media data; and
generating the second media data using the plurality of audio segments.

6. The method of claim 5, wherein a target audio segment in the plurality of audio segments satisfies the following conditions:
a time length of the target audio segment satisfying a predetermined length condition;
energy of the target audio segment satisfying a predetermined energy condition; and
a pitch difference of the target audio segment satisfying a predetermined pitch condition.

7. The method of claim 5, wherein the second media data is generated based on the following:
selecting, from the plurality of audio segments, a set of audio segments corresponding to the set of notes, a target note in the set of notes corresponding to a target audio segment in the set of audio segments; and
creating the second media data using the set of audio segments.

8. The method of claim 7, wherein the target audio segment is selected based on at least one of the following:
a random selection mode;
a poll selection mode;
comparison of a time length corresponding to the target note with a time length of the target audio segment; and
comparison of a pitch corresponding to the target note with a pitch of the target audio segment.

9. The method of claim 7, wherein the second media data is created based on the following:
adjusting pitches and time lengths of the set of audio segments respectively to match the set of notes; and
combining the adjusted set of audio segments to generate the second media data.

10. The method of claim 9, wherein a pitch of the target audio segment in the set of audio segments is adjusted based on at least one of: performing resampling on the target audio segment, and scaling a time length of the target audio segment.

11. The method of claim 7, wherein the first media data and the second media data comprise video data, and a video portion in the second media data is generated based on the following:
obtaining a set of video segments respectively corresponding to the set of audio segments; and
generating the video portion in the second media data using the set of video segments.

12. The method of claim 1, wherein the melody data is represented using at least one of: audio data and note data.

13. The method of claim 1, wherein the creation request further specifies a musical instrument for creating the music, and the first media data and the second media data are played by using the musical instrument.

14. An electronic device, comprising:
at least one processing unit; and
at least one memory coupled to the at least one processing unit and storing instructions for execution by the at least one processing unit, wherein the instructions, when executed by the at least one processing unit, cause the electronic device to perform at least:
in response to receiving a creation request for creating music, obtaining first media data;
obtaining a music template, the music template comprising melody data for specifying a music melody; and
generating second media data comprising the music melody based on the first media data.

15. The electronic device of claim 14, wherein the second media data and the first media data have a same timbre and the timbre is specified by the first media data.

16. The electronic device of claim 14, wherein the music template further comprises accompaniment data and the second media data further comprises the accompaniment data.

17. The electronic device of claim 14, wherein the music template further comprises style data for specifying a music style, and the second media data further has the music style.

18. The electronic device of claim 14, wherein the melody data comprises a set of notes, each note in the set of notes corresponds to a respective time length, and the second media data is generated by the following:
dividing the first media data into a plurality of audio segments based on pitch information in the first media data; and
generating the second media data using the plurality of audio segments.

19. The electronic device of claim 18, wherein a target audio segment in the plurality of audio segments satisfies the following conditions:
a time length of the target audio segment satisfying a predetermined length condition;
energy of the target audio segment satisfying a predetermined energy condition; and
a pitch difference of the target audio segment satisfying a predetermined pitch condition.

20. A non-transitory computer-readable storage medium having stored thereon a computer program which, when executed by a processor, causes the processor to perform at least:
in response to receiving a creation request for creating music, obtaining first media data;
obtaining a music template, the music template comprising melody data for specifying a music melody; and
generating second media data comprising the music melody based on the first media data.
